(19) United States
(12) Patent Application Publication
(10) Pub. No.: US 2017/0098192 A1
(43) Pub. Date: Apr. 6, 2017

(54) CONTENT AWARE CONTRACT IMPORTATION

(71) Applicant: Adobe Systems Incorporated, San Jose, CA (US)

(72) Inventor: BENJAMIN D. FOLLIS, London (GB)

(73) Assignee: ADOBE SYSTEMS INCORPORATED, San Jose, CA (US)

(21) Appl. No.: 14/873,593

(22) Filed: Oct. 2, 2015

(51) Int. Cl. G06Q 10/10

(52) U.S. Cl. CPC G06Q 10/10

(57) ABSTRACT

Techniques are provided for content aware contract importation that automatically and fully import and integrate non-electronic contracts into an electronic contract system. In one implementation, the electronic contract system is configured to receive information descriptive of a contract, analyze the information using one or more contract models to identify and extract metadata descriptive of the contract being imported, and store the metadata in association with an electronic version of the contract in the electronic contract system. In some cases, information native to a user account but not to the contract being imported is used in analyzing the contract.

### FIELD OF THE DISCLOSURE

This disclosure relates generally to contract processing, and more specifically to contract importation that analyzes contract content.

### BACKGROUND

Computers and electronic documents have become an increasingly indispensable part of modern life. In particular, electronic contracts have gained acceptance as a convenient replacement for conventional paper contracts. When negotiating parties reach an agreement with respect to a course of action, state of affairs, or other subject matter, the resulting agreement is usually reduced to writing and executed by the parties as a contract to memorialize the terms of the agreement. Traditionally, a physical copy of the contract was executed with a personalized stamp, seal, or handwritten signature. However, since this “reduction to writing” now often takes the form of an electronic contract stored on a computer readable medium, electronic signatures have become commonplace and have indeed gained widespread legal recognition. See, for example, the Electronic Signatures in Global and National (ESIGN) Commerce Act, 15 U.S.C. §96.

Although electronic contracts have gained widespread acceptance, many conventional contracts exist and more are created each day. Importing these contracts into an electronic database typically involves scanning a hard copy of an existing agreement to make an electronic image of that agreement, and then storing that electronic version in a given database. Further interaction with the electronic version of the contract generally involves opening of the electronic document by an interested person, and viewing the details of that document. The document may then be classified or otherwise characterized as desired by that person. In some instances, the electronic image of document may be converted to text to improve its searchability.

### BRIEF DESCRIPTION OF THE DRAWINGS

FIG. 1 is a block diagram illustrating selected components of an example electronic contract system in accordance with embodiments disclosed herein.

FIG. 2A is a schematic illustration of selected components of an electronic contract in accordance with embodiments disclosed herein.

FIG. 2B is a schematic illustration of another example of an electronic contract in accordance with embodiments disclosed herein.

FIG. 3 is a flowchart illustrating an example contract importation process in accordance with embodiments disclosed herein.

FIG. 4 is a flowchart illustrating an example classification data generation process in accordance with embodiments disclosed herein.

### DETAILED DESCRIPTION

Many users of electronic contract systems have a significant number of contracts that are not in electronic format. These non-electronic or “legacy” contracts may still be in force, but lack the ease of viewing, access control, auditability, and many other benefits that electronic contract systems provide. Importing these legacy contracts into a conventional electronic contract system can be difficult, even if all parties to the contract already are users of the electronic contract system. While conventional electronic contract systems allow users to upload a copies of legacy contracts into the system, these copies do not benefit from the rich set of metadata available to natively originated electronic contracts. While some metadata may be manually entered after a copy is uploaded, such manual data entry is costly and prone to error. Also, in many instances, the volume of data entry work may be cost prohibitive when compared to the perceived benefit of fully integrating copies of legacy contracts into the electronic contract system. For this reason, many of the features of conventional electronic contract systems described above are not available for electronic copies of legacy contracts.

Thus, and in accordance with certain of the embodiments disclosed herein, techniques are provided for content aware contract importation that automatically and fully import and integrate non-electronic contracts into an electronic contract system. In one implementation, the electronic contract system is configured to receive information descriptive of an existing non-electronic contract to be imported into the system, analyze the information using one or more pre-established contract models to identify and extract metadata descriptive of the contract being imported, and store the metadata in association with an electronic version of the contract in the electronic contract system. The information descriptive of the contract may be received as text, images, audio or a combination thereof. For instance, the information descriptive of the contract may include any evidence of an existing contract, such as an image or PDF file or text file of a written contract, or an audio file of a verbal contract, or some other contract form). Where a contract is described by two or more independent sources (e.g., text and audio) the data received from those independent sources may be fused to increase the discriminatory power of the content analysis. Other such leveraging of the available information descriptive of the contract may be performed at various stages of processing to render electronic contract data and metadata that are usable by the analysis techniques provided herein.

As indicated above, the electronic contract system analyzes electronic contract data using one or more contract models. As will be appreciated in light of this disclosure, a contract model is a model used for comparative purposes and is constructed based on an analysis of content of existing (accessible) contracts associated with a given commonality. The commonality associated with a given group of existing contracts may be, for instance, the name of a particular user or party, or a contract type (e.g., non-disclosure agreements, assignments, licenses, etc), or a particular contract structure (e.g., certain section headings arranged in a particular order). Each commonality can have a different model, or multiple models, depending on the granularity of the contract modeling scheme. In any case, a given contract model of a group of one or more existing contracts can be used to indicate field locations and input information typical of that contract group, according to some embodiments. Such models can then in turn be used to determine likely field locations of a newly imported contract through a comparative process and therefore help to classify or otherwise inbound that new contract into the electronic contract system. To this end, “execution” of a contract model as referred to herein is intended to refer to a comparative process for purposes of classifying a new contract based on existing contracts. In some embodiments, these contract models may employ a variety of cluster and content analysis techniques to identify salient portions and characteristics of inbound electronic contracts. These cluster and content analysis techniques may range, for example, from keywords searches to classification of electronic contracts by complex neural networks or other machine learning devices.

In some embodiments, the contract models are provided with classification data. As used herein, the term “classification data” refers, in addition to its ordinary meaning, to information descriptive of patterns of data targeted for identification by a contract model. In some embodiments, the electronic contract system generates classification information from a corpus of electronic contracts already extant in or otherwise available to the electronic contract system. In other embodiments, the electronic contract system generates classification information from a single, inbound contract, which is used as a “seed” or baseline for future importations. The classification data may include, for example, data descriptive of headings, indicative characters, punctuation, syntax, fonts, graphics, intensity, pitch, and/or tone of audio data, image data, descriptors of image data, locations of data within the electronic contract, spatial or temporal relationships between data (e.g., words, whitespace, silence) within the electronic contract or any other detectable attribute of data included in electronic contracts or metadata descriptive of the electronic contracts. As described further below, in some embodiments, classification data is stored as one or more feature vectors, to facilitate comparison. Other suitable formats that facilitate comparison and analysis can be used as well. The electronic contract system may use classification data to a variety of ends. For example, in some embodiments, classification data is used to train an artificial neural network to classify electronic contracts, fields within the electronic contracts, or other portions of electronic contract data. In other embodiments, classification data is organized into an exemplar contract with fields that are referenced during execution of the contract model. As will be explained in turn, the electronic contract system “executes” or otherwise uses the contract model to generate and store the contract data itself and metadata for the contract. The metadata may be native to the contract and/or derived from other sources external to the contract.

In some embodiments, the particular contract model or models executed by the electronic contract system are keyed on and specific to a user, one or more parties to the contract, types of contracts, or other categories sharing a common trait. In these embodiments, the electronic contract system selects one or more particular contract models to execute for a particular inbound contract based on the characteristics of the inbound contract. These characteristics may include, for example, one or more parties to the contract and the type of contract, among other characteristics.

As previously indicated, once a contract model is selected, the electronic contract system executes or otherwise uses the contract model to generate and store metadata for the electronic contract. Upon completion of the contract model's execution, the electronic contract system has stored metadata for the electronic contract, in addition to the electronic contract itself, as if the electronic contract were natively originated. In some embodiments, the contract model, during execution, attempts to identify fields in the electronic contract by parsing the electronic contract into portions via one or more clustering processes. These clustering processes may be informed by classification data, such as keywords and titles, and by user account data, such as the name or another identifier of a user. In these embodiments, the contract model may also utilize content analysis processes that calculate similarities between data associated with clusters in electronic contract and data representative of particular fields in other electronic contracts in an effort to identify a field type for each cluster.

After execution of the contract model is complete, the electronic contract system may perform a variety of actions. For example, in one embodiment, the electronic contract system displays the results of its importation process and prompts or otherwise gives the user an opportunity to confirm or correct those results. In another embodiment, the electronic contract system checks to determine whether a newly imported electronic contract is a copy of an electronic contract already present in or otherwise available to the electronic contract system. If so, the electronic contract system may further prompt the user to confirm that the user wishes to keep the redundant copy in the system, or to store multiple copies of the contract under different party names or other suitable descriptor that can be used to discern the different engagements associated with each executed instance of the contract. In another embodiment, the electronic contract system notifies all parties to the electronic contract of the contract's importation and prompts the parties to confirm their consent to the importation. Other post importation workflows are possible and the embodiments disclosed herein are not limited to a particular post importation workflow or set of workflows.

As used herein, the term “contract” refers, in addition to its ordinary meaning, to any legally binding agreement between two or more parties. A contract can take the form of a physical object, such as one or more papers containing printed information, or in the case of an “electronic contract”, a computer readable medium containing digital data. In the latter case, note that the digital data may be representative of a written contract (e.g., PDF or image file depicting the contract) or a verbal contract (e.g., audio file). Electronic contracts can be rendered in a variety of different ways, such as via display on a screen, by printing using an output device, or aurally using an audio player and/or text-to-speech software. Thus it will be appreciated that electronic contracts may include digital assets in addition to or instead of text; such digital assets may include, for example, audio clips, video clips, photographs, and other multimedia assets. For instance, both a word processing file containing the terms of a legally enforceable contract as well as a compressed audio file containing an audio recording of the same contract terms would be considered “contracts” for the purposes of this disclosure. Such textual and audio components may be combined into a single document in certain embodiments. As used herein, the term “field” refers, in addition to its ordinary meaning, to a portion of an electronic contract.

As used herein, the term “pre-established contract model” refers, in addition to its ordinary meaning, to a contract model as described herein that is available for use as a resource to identify and extract metadata descriptive of a contract during importation of the contract. Pre-established contract models may include and utilize classification data to achieve these objectives. Examples of pre-established contract models include exemplar contracts and artificial neural networks. A given contract model may be based on a single contract, or a hybrid of multiple contracts having a number of common features. In a more general sense, a contract model is a classification tool that can be used to classify and analyze a newly provided contract.

System Architecture

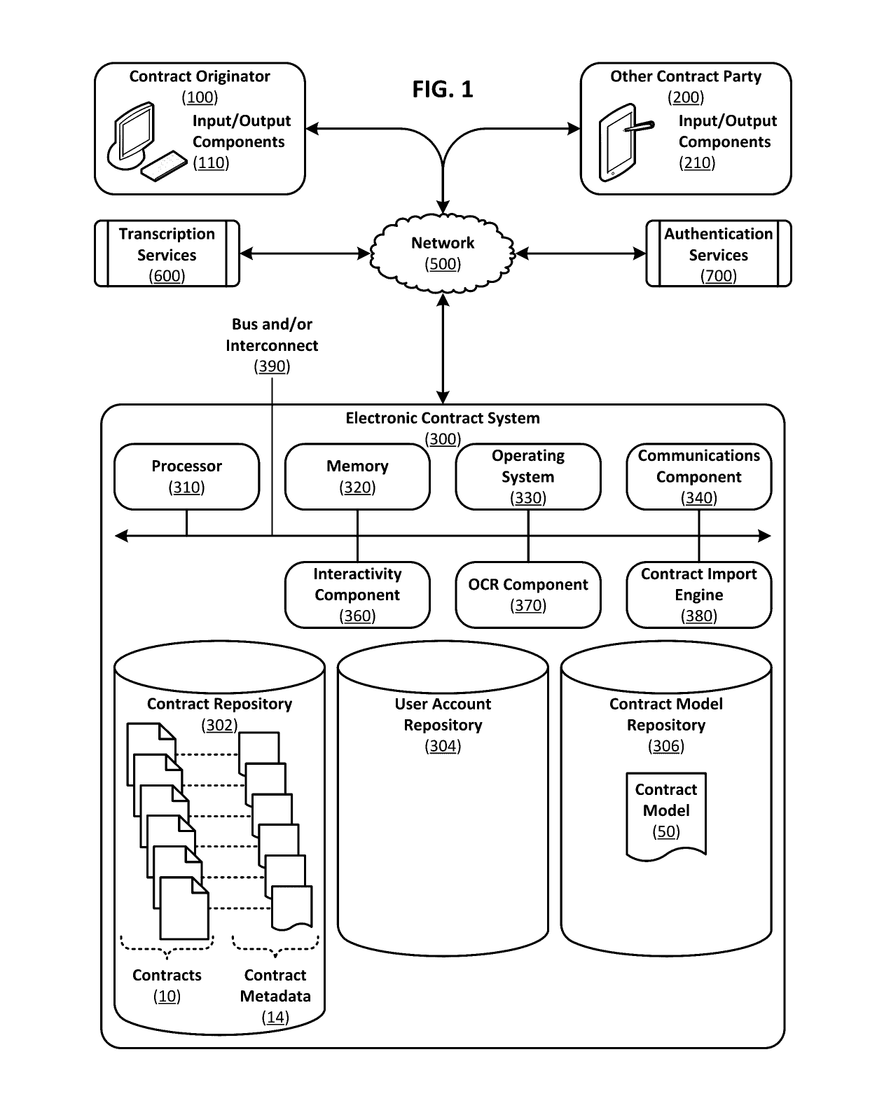

FIG. 1 is a block diagram illustrating selected components of an example system configured to automatically import conventional contracts into an electronic contract system. More specifically, the system illustrated in FIG. 1 can be understood as enabling a contract originator 100 and at least one other contract party 200 to benefit from and optionally oversee and control automatic importation of conventional contracts into an electronic contract system 300. The at least one other contract party 200 may include a plurality of parties to the contract.

In some embodiments, devices associated with the contract originator 100, devices associated with the other contract party 200, and the electronic contract system 300 communicate with each other via a network 500. The network 500 can also be used to access supplementary services and resources, such as transcription services 600 and/or authentication services 700. Additional or alternative services and resources may be provided in other embodiments. In some cases one or more of such services and resources may be integrated into and provided by one or more of the device associated with the contract originator 100, the device associated with the other contract party 200, and/or the electronic contract system 300, as will be described in turn. Thus other embodiments may have fewer or more networked services and/or resources depending on the implementation. It will therefore be appreciated that the embodiments disclosed herein are not intended to be limited to the provision or exclusion of any particular services and/or resources.

As illustrated in FIG. 1, the contract originator 100 and the other contract party 200 each have access to a device that facilitates interaction with other users and/or other components of the various systems that are illustrated in FIG. 1 and/or are otherwise described herein. For example, in certain embodiments the contract originator 100 and the other contract party 200 each have access to one or more of a variety of suitable computing devices, including devices such as desktop computers, laptop computers, workstations, enterprise class server computers, handheld computers, tablet computers, cellular telephones, smartphones, and set-top boxes. Other devices may be used in other embodiments. The device used by the contract originator 100 and/or the other contract party 200 optionally includes a wired and/or wireless communication adapter that enables communication via the network 500. The device also optionally includes input/output components 110, 210 such as one or more of a tactile keyboard, a display, a touch sensitive display, a microphone, a camera, scanner, and location services. In some embodiments, the input/output components include optical character recognition (OCR) components.

Referring still to the example embodiment illustrated in FIG. 1, the electronic contract system 300 can be configured to automatically import a contract provided by a device associated with the contract originator 100. When executing according to this configuration, the electronic contract system 300 automatically identifies salient characteristics of the contract and stores metadata descriptive of the salient characteristics. These salient characteristics may include one or more electronic contract fields. Electronic contract fields organize information recited in an electronic contract into portions that include common and reoccurring contractual provisions. Examples of fields that are present in many electronic contracts include titles, parties to the contract, whereas clauses, representations, warranties, consideration, statements of work, payment terms, termination clauses, limitations of liability, signatures, effective date, execution date, merger clauses, venue clauses, governing law provisions, and the like.

In some embodiments, the electronic contract system 300 includes one or more software components configured to implement certain of the functionalities disclosed herein, and optionally further includes hardware configured to enable such implementation. This hardware may include, but is not limited to, a processor 310, a memory 320, an operating system 330, and a communications component 340. The processor 310 can be any suitable processor, and may include one or more coprocessors or controllers, such as an audio processor or a graphics processing unit, to assist in processing operations of the electronic contract system 300. The memory 320 can be implemented using any suitable type of digital storage, such as one or more of a disk drive, a universal serial bus drive, flash memory, and/or random access memory. The operating system 330 may comprise any suitable operating system, such as Google Android (Google Inc., Mountain View, Calif.), Microsoft Windows (Microsoft Corp., Redmond, Wash.), or Apple OS X (Apple Inc., Cupertino, Calif.). As will be appreciated in light of this disclosure, the techniques provided herein can be implemented without regard to the particular operating system provided in conjunction with the electronic contract system 300, and therefore may also be implemented using any suitable existing or subsequently-developed platform. The communications component 340 can be any appropriate network chip or chipset which allows for wired and/or wireless communication via the network 500 to one or more of the other components described herein. A bus and/or interconnect 390 may also be provided to allow for inter- and intra-device communications using, for example, the communications component 340.

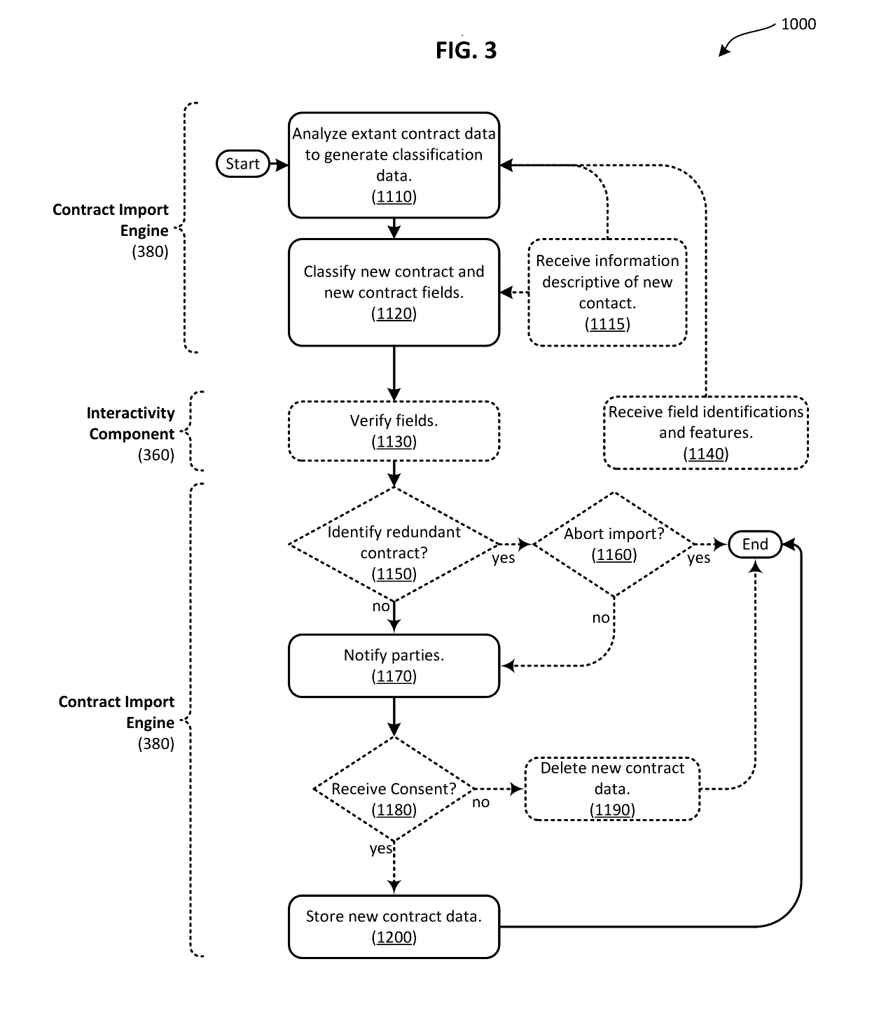

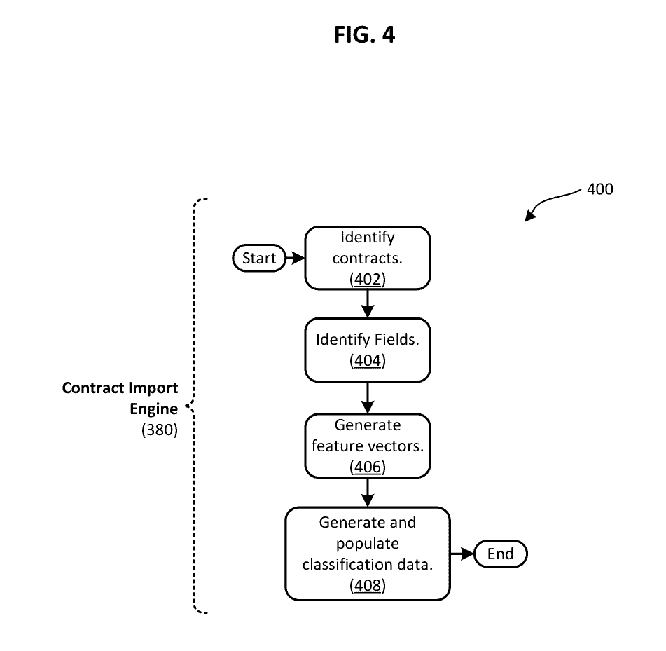

The processor 310 may be implemented with a general purpose processor. However, when executing a specific software process as provided herein (e.g., FIGS. 3 and 4), the processor 310 becomes a special purpose processor capable of making specific logic-based determinations based on input data received, and further capable of providing one or more outputs that can be used to control or otherwise inform subsequent processing to be carried out by the processor 310 and/or other processors or circuitry with which processor 310 is communicatively coupled. Thus, the processor 310 reacts to specific input stimulus in a specific way and generates a corresponding output based on that input stimulus. In this sense, the structure of processor 310 according to one embodiment is defined by the flow charts shown in FIGS. 3 and 4. In some example cases, the processor 310 proceeds through a sequence of logical transitions in which various internal register states and/or other bit cell states internal or external to the processor 310 may be set to logic high or logic low. This specific sequence of logic transitions is determined by the state of electrical input signals to the processor 310 and a special-purpose structure is effectively assumed by the processor 310 when executing each software instruction of the software process shown in FIGS. 3 and 4. Specifically, those instructions anticipate the various stimulus to be received and change the implicated memory states accordingly. In this way, the processor 310 may generate and store or otherwise provide useful output signals. Thus, it is appreciated that the processor 310, during execution of a software process becomes a special purpose machine, capable of processing only specific input signals and rendering specific output signals based on the one or more logic decisions performed during execution of each software instruction. As referred to herein, the processor 310 is configured to execute a function where software is stored in a data store coupled to the processor 310 that is configured to cause the processor to proceed through a sequence of various logic decisions that result in the function being executed.

The electronic contract system 300 may also include an interactivity component 360 configured to provide an interactivity interface to users accessing the electronic contracts and resources managed by the electronic contract system 300. Such an interface may be provided by way of a graphical user interface rendered on a digital display, although other types of interfaces can be implemented as well, including voice response interfaces, telephone touchtone interfaces, and textual interfaces. Such interfaces can be provided to the contract originator 100 and/or the other contract party 200. For example, in one embodiment the interactivity component 360 is configured to generate a graphical user interface capable of receiving commands, parameters, textual input, graphical input, audiovisual recordings and/or other data. The interactivity component 360 can also be configured to receive and process incoming import notifications for the contract originator 100, the other contract party 200, and third parties. Such processing may include prompting additional actions from specified parties.

The electronic contract system 300 may also include an OCR component 370. The OCR component 370 may be configured to receive graphical input and generate textual output representative of the symbols present in the graphical input. For example, an electronic copy of a contract can be provided to the system 300 as an image (e.g., TIFF, scanned portable document format or pdf document), and the OCR component 370 can be used to convert such imaged documents into text documents. Subsequent content analysis of the document can then be carried out using the text and/or the image.

The electronic contract system 300 also optionally includes a contract import engine 380. The contract import engine 380 can be configured to automatically import contracts into the electronic contract system 300. At least one example of an importation processes that the contract import engine 380 is configured to execute is described further below with reference to FIGS. 3 and 4. To this end, in certain embodiments the contract import engine 380 is associated with and accesses information stored in a contract repository 302 and a user account repository 304. In some embodiments, the user account repository can be configured to store information descriptive of users of the system (e.g., the contract originator 100). This information may be descriptive of the user's name, address, company, contracts to which the user is a party, policies regarding importation of new contracts, and other attributes of or related to users of the electronic contract system 300. In other embodiments, the contract repository 302 can be configured to store a plurality of electronic contracts 10 to which the contract originator 100 and/or the other contract party 200 are bound. One or more of the electronic contracts 10 are associated with contract metadata 14 that, for example, defines characteristics (e.g., fields) of the contract, defines contract status information (such as whether the importation of the contract is in-process or final), defines an audit trial for each electronic contract 10, and/or defines any other supplemental information associated with the contract. The audit trail for each electronic contract 10 may include, for example, information that describes a chronology of an importation process through which the electronic contract 10 was added to the electronic contract system 300.

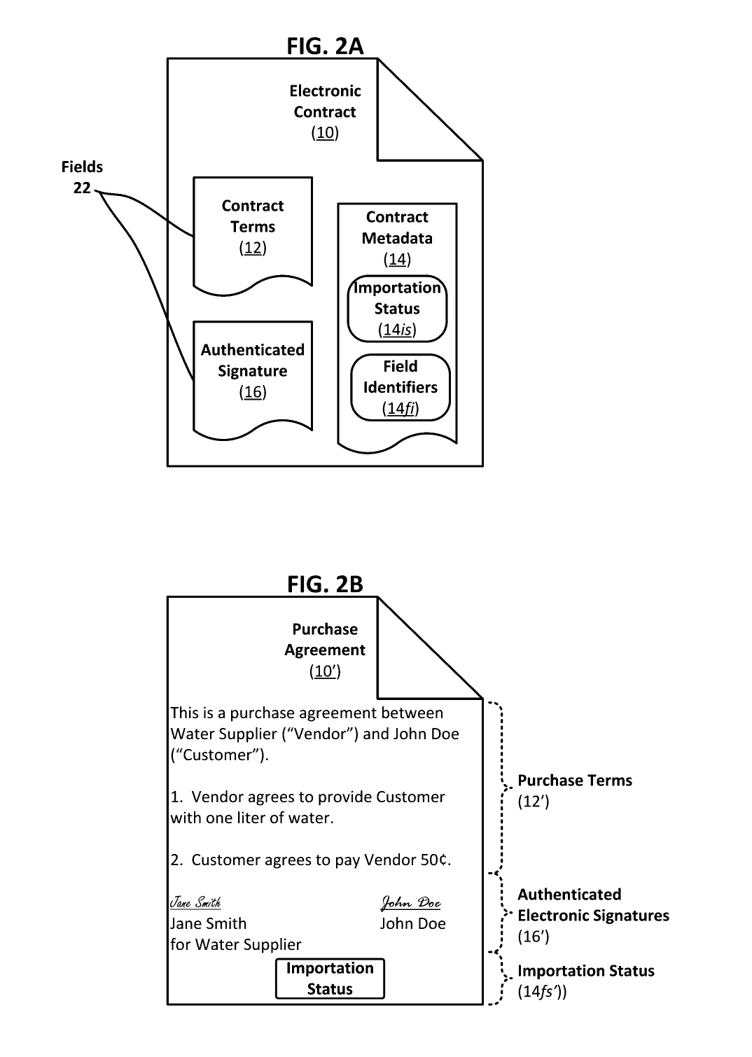

As schematically illustrated in FIG. 2A, in addition to the contract metadata 14 a given electronic contract 10 may include other components such as terms 12 and an authenticated electronic signature 16. Both the terms 12 and the authenticated electronic signature are also fields 22 of the electronic contract. The contract metadata 14 includes, among other things, an importation status value 14is of the electronic contract 10 and field identifiers 14fi that identify the locations and types of fields included in the electronic contract 10. To provide a more specific example of the electronic contract 10, FIG. 2B schematically illustrates a purchase agreement 10′ that includes a plurality of purchase terms 12′ and a plurality of authenticated electronic signatures 16′. The importation status value 14is′ is represented by a hyperlink that is associated with a network address where an importation status value of the purchase agreement 10′ is stored.

As described herein, certain embodiments include supplementary resources and/or services, such as the transcription services 600 and/or the authentication services 700. The transcription services 600 may include a text-to-speech component and/or a speech-to-text component which can be used to generate an audio version of a document or transcribe a spoken response received from the other contract party 200, respectively. The authentication services 700 can be configured to authenticate and authorize the contract originators 100, the other contract party 200, and third parties before providing access to resources and/or electronic contracts stored in with the electronic contract system 300. For example, authentication may be required before contract importation is accepted. Authentication can be provided by any appropriate existing or subsequently developed authentication scheme. For example, in certain embodiments a user can be required to provide a password, a public key, a private key, or other authorization token before being able to view a contract or authorize contract importation. Providing such services by networked resources advantageously eliminates any need for such services to be provided locally at a device used by the contract originator 100 or the other contract party 200. This allows users to leverage the functionality provided by the electronic contract system 300 without any need to obtain specialized hardware or software, thereby providing networked functionality to users of devices having limited processing capability, such as public kiosks, smartphones, and tablet computers. Thus in certain embodiments the transcription services 600 and/or the authentication services 700 may be integrated into and provided by electronic contract system 300.

The contract originator 100, the other contract party 200, and the electronic contract system 300 can communicate with each other via the network 500. The network 500 can also be used to access supplementary services and resources, such as the transcription services 600 and the authentication services 700. The network 500 may be a local area network (such as a home-based or office network), a wide area network (such as the Internet), or a combination of such networks, whether public, private, or both. For example, in certain embodiments at least a portion of the functionality associated with the network 500 is provided by a cellular data network, thereby making it easier for users of smartphones and other mobile devices to interact with the electronic contract system 300. In general, communications amongst the various entities, resources, and services described herein may occur via wired and/or wireless connections, such as may be provided by Wi-Fi or mobile data networks. In some cases access to resources on a given network or computing system may require credentials such as a username and password, and/or may require compliance with any other suitable security mechanisms. Furthermore, while only one contract originator 100 and one other contract party 200 are illustrated in the example embodiment of FIG. 1, it will be appreciated that in general the system may comprise a distributed network of tens, hundreds, thousands, or more contract originators 100 and/or other contract parties 200 capable of interacting with a correspondingly large number of electronic contract systems 300.

The embodiments disclosed herein can be implemented in various forms of hardware, software, firmware, and/or special purpose processors. For example, in one embodiment a non-transitory computer readable medium has instructions encoded thereon that, when executed by one or more processors, cause one or more of the automated methods for tracking and notification of fulfillment events disclosed herein to be implemented. The instructions can be encoded using any suitable programming language, such as C, C++, object-oriented C, JavaScript, Visual Basic .NET, BASIC, or alternatively, using custom or proprietary instruction sets. Such instructions can be provided in the form of one or more computer software applications and/or applets that are tangibly embodied on a memory device, and that can be executed by a computer having any suitable architecture. In one embodiment the system can be hosted on a given website and implemented, for example, using JavaScript or another suitable browser-based technology.

The functionalities disclosed herein can optionally be incorporated into other software applications, such as document management systems or document viewers. For example, an application configured to view portable document format (PDF) files can also be configured to implement certain of the functionalities disclosed herein upon detecting the presence of signature fields or other metadata in a given contract, including signature fields intended for a handwritten signature. The systems disclosed herein may also optionally leverage services provided by other software applications, such as electronic mail readers. The computer software applications disclosed herein may include a number of different components, sub-components, or other components of distinct functionality, and can provide information to, or receive information from, still other components and/or subcomponents. These components can be used, for example, to communicate with input and/or output devices such as a display screen, a touch sensitive surface, a printer, and/or any other suitable input/output device. Other components and functionality not reflected in the illustrations will be apparent in light of this disclosure, and it will be appreciated that the various embodiments disclosed herein are not limited to any particular hardware or software configuration. Thus in other embodiments the electronic contract system 300 may comprise additional, fewer, or alternative subcomponents as compared to those included in the illustrated embodiments.

The aforementioned non-transitory computer readable medium may be any suitable medium for storing digital information, such as a hard drive, a server, a flash memory, and/or random access memory. In alternative embodiments, the computer and/or components disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that the present disclosure is not intended to be limited to any particular system architecture.

### Example Scenario

Referring again to FIG. 1, in one implementation the contract originator 100 represents a lender and the other contract party 200 represents a borrower. In this implementation the lender and borrower can both use a variety of different computing devices, each having a corresponding variety of different input/output components 110, 210, to interact with the system illustrated in FIG. 1. The lender possesses a written copy of a valid and binding loan agreement that has been executed by the borrower. The lender scans the copy and submits data representative of the copy to the electronic contract system 300 via an interface. In this implementation, the data representative of the copy is an image stored in a TIFF file, although other types of files (PNG, JPEG, etc.) may be used in other implementations. In addition, in some implementations, the data representative of the copy is text generated by OCR components 370 implemented within the input/output component 110 described above. In these implementations, the network 500 may benefit from decreased bandwidth consumption due to the decreased size of a textual rendering of the copy as compared to a TIFF or other graphical rendering.

Continuing with this example, in response to receiving the TIFF file, the electronic contract system 300 processes the TIFF file to automatically import the loan agreement as an electronic contract, thereby availing the lender and the borrower to all of the benefits of electronic contracts as described herein. This importation process is content aware in that it automatically identifies contract metadata represented within the TIFF file and stores of the contract metadata in association with the electronic contract. This metadata may be used by other components of the electronic contract system, such as searching, viewing, controlling, and auditing components. While this example implementation involves the importation of a loan agreement, it will be appreciated that other implementations involve a wide range of other types of contracts.

Methodology

FIG. 3 illustrates an example automatic importation process 1000 configured to automatically import contracts. As can be seen, the importation process 1000 includes a number of phases and sub-processes, the sequence of which may vary from one embodiment to another. However, when considered in the aggregate, these phases and sub-processes form an automated process for automatically importing contracts in accordance with certain of the embodiments disclosed herein. This process can be implemented, for example, using the system architecture illustrated in FIG. 1 and described herein. However other system architectures can be used in other embodiments, as will be apparent in light of this disclosure. To this end, the association of the various actions shown in FIG. 3 to the specific components illustrated in FIG. 1 is not intended to imply any structural and/or use limitations. Rather, other embodiments may include, for example, varying degrees of integration where multiple actions are effectively performed by one system. For example, in an alternative embodiment a single component is used to provide user interactivity and automatically import contracts. Thus other embodiments may have fewer or more components depending on the architecture of the embodiment. Numerous variations and alternative configurations will be apparent in light of this disclosure.

As illustrated in FIG. 3, the importation process 1000 starts with act 1110 where a contract import engine (e.g., the contract import engine 380) analyzes the content of a plurality of electronic contracts (e.g., the electronic contracts 10) to generate classification data for one or more contract models (e.g., the contract model 50). The goal of this analysis is create a contract model and classification data that may be used to accurately classify fields present in new contracts during importation of the new contracts. The act 1110 may be automatically triggered by an electronic contract system executing the importation process 1000 (e.g., the electronic contract system 300) or by receipt by the electronic contract system of information descriptive of a new contract for importation from a device associated with a user (e.g., the contract originator 100). Such receipt of information descriptive of a new contract is illustrated in FIG. 3 as act 1115, which is rendered using dashed lines to indicate it is optional.

In various embodiments, the classification data and associated contract models generated in the act 1110 may be indexed, searched, and retrieved by analysis of contract feature vectors. These contract feature vectors describe the classification data and contract models. For example, contract feature vectors may include one or more elements that indicate the users, contract types, and/or other features of the electronic contracts used to generate the classification data. In these embodiments, more specialized classification data and contract models (e.g., those specific to a user and/or contract type) may provide increased accuracy in classifying fields in new electronic contracts when compared to less specialized classification data and contract models (e.g., those not specific to the user and/or the contract type).

FIG. 4 illustrates one example of a classification data generation process 400 that may be executed in the act 1110. As shown in FIG. 4, the generation process 400 starts with act 402 where the contract import engine identifies each electronic contract to be analyzed via each electronic contracts inclusion of one or more target characteristics. These target characteristics may include, for example, one or more parties (e.g. the user) and/or one or more contract types (e.g., service agreement, assignment, etc.).

In some embodiments, the contract model engine identifies electronic contracts as having one or more configurable target characteristics by comparing field identifiers in the electronic contract with target field identifiers. The field identifiers may be stored in metadata (e.g., the metadata 14) descriptive of the electronic contract. The target field identifiers to which the contract import engine compares field identifiers of electronic contracts may be stored in metadata associated with the user's account (e.g., metadata identifying the user, the electronic contracts to which the user is a party, and/or contract types). Where the field identifiers in an electronic contract match (e.g. are equal to or are in some other predefined relationship with) the target field identifiers, the contract model engine identifies the electronic contract as having the one or more target characteristics and associates the electronic contract with a corpus of contracts to be subsequently processed as described below.

In various embodiments, the contract model engine may use various sets of target characteristics to create corpora of contracts of varying size. For instance, in one example the target characteristics specify that only electronic contracts to which the user is a party are to be associated with the corpus. While in another example, the target characteristics may specify that electronic contract to which the user is a party and electronic contracts to which other users (e.g., the other user 200) are parties are to be associated with the corpus. In still another example the target characteristics may specify that all electronic contracts in the electronic contract system are to be associated with the corpus. Thus the embodiments disclosed herein are not limited to a particular set of target characteristics or size of corpus.

In act 404, the contract import engine identifies one or more fields within each electronic contract associated with the corpus of contracts. Various embodiments execute the act 404 via a variety of processes. For instance, in one embodiment, the contract import engine identifies fields by accessing annotations stored in the metadata that include predefined field identifiers that indicate portions of the electronic contracts as being instances of particular fields.

In another embodiment where identifying metadata is not available or inconclusive (e.g., where the metadata does not include predefined field identifiers), the contract import engine identifies fields using cluster and content analysis. Specific clustering processes that may be executed by the contract import engine in the act 404 include centroid-based clustering, density-based clustering, distribution-based clustering, and hierarchical clustering, among others. Responsive to identifying one or more clusters of data in each electronic contract, the contract import engine next attempts to associate one or more field identifiers with the one or more clusters of data by executing a content analysis process. During this association process, the one or more clusters may be adjusted based on features known to be associated with the one or more field identifiers. For example, if a field identified by the field identifier is recorded as having a fixed size of 200 words, the contract import engine may adjust a cluster of data otherwise deemed to be identifiable by the field identifier to have a fixed size of 200 words.

The specific content analysis process executed by the contract import engine may vary between embodiments. For example, in one embodiment, the contract import engine analyzes the content of the clusters by searching for keywords and/or other features in the one or more clusters. These keywords and other features may be associated with one or more field identifiers via express user configuration or via previous content analysis of a different corpus of electronic contracts (e.g., electronic contracts having parties other than the user, such as the other party to the contract, and/or being of a variety of types). In this embodiment, the contract import engine automatically associates field identifiers with clusters of data that include the keywords and/or other features.

In another embodiment, in the act 404 the contract import engine constructs a discrete feature vector for each cluster. Each newly constructed feature vector is descriptive of the data included in its associated cluster. In this embodiment, the contract import engine calculates a distance between the feature vector associated with a cluster and one or more field feature vectors associated with one or more field identifiers. The field feature vectors may be generated using keywords, user account data (e.g., user name or some other user identifier), and/or other features of data associated with one or more fields identified by the one or more field identifiers. These keywords and other features may be associated with the one or more field identifiers via express user configuration or via previous content analysis of a different corpus of electronic contracts (e.g., electronic contracts having parties other than the user, such as the other party to the contract, and/or being of a variety of contract types). Some examples of data, in addition to keywords and user account data, that may be associated with fields and that may be reflected in these feature vectors, or that may be used directly in the feature vectors, include data descriptive of headings, indicative characters, punctuation, syntax, fonts, graphics, intensity, pitch, and/or tone of audio data, image data, descriptors of image data, locations of data within the electronic contract, spatial or temporal relationships between data (e.g., words, whitespace, silence) within the electronic contract or any other detectable attribute of content included in the electronic contracts or metadata descriptive of the electronic contracts.

Where the distance between a feature vector associated with a cluster and a field feature vector associated with a field identifier is below a threshold value (and, in some examples, lower than other calculated distances involving the feature vector associated with the cluster), the contract import engine stores a field identifier that associates the data in the cluster with a field type that is the same as the field type associated with the field feature vector.

In other embodiments, the contract import engine may request that an interactivity component (e.g., the interactivity component 360) prompt the user for input specifying one or more field identifiers to be associated with one or more clusters of data. In response to receiving this input, the contract import engine may store one or more user specified field identifiers in association with the one or more clusters of data.

It is appreciated that the field identification techniques described above may be combined in various embodiments. For example, in one embodiment, the contract import engine first attempts to identify fields using field identifiers stored in the metadata. The contract import engine next attempts to identify any remaining unidentified fields using cluster and content analysis. Finally, the contract import engine next requests that a user identify any remaining unidentified fields expressly via input and/or correct any low confidence identifications made by the clustering and content analysis processes. In some embodiments, a low confidence identification results where, for example, a distance between a feature vector describing data associated with a field in an electronic contract and a field feature vector associated with a field identifier is below a first configurable threshold but above a second configurable threshold. In these embodiments, the first configurable threshold may be a value that indicates with a low confidence identification and the second configurable threshold may be a value that indicates a high confidence identification.

In act 406, the contract import engine generates a set of features vectors that are associated with the fields identified in the act 404 and descriptive of the data associated with those fields. Feature vectors created in the act 406 are generally better discriminators than the field feature vectors used to supplement field identifications in act 404 because the feature vectors created in the act 406 are specific to the corpus of contracts identified in the act 402. For example, in at least one embodiment, the contract import engine identifies frequently occurring words that are not stop words within the data associated with each field and generates a feature vector including the identified words. In this embodiment, words are identified as frequently occurring where the occurrence of the words exceeds a predefined configurable threshold. This predefined configurable threshold may be based on the total number of words in the data associated with the field.

The data processed by the contract import engine in the act 406 to generate feature vectors may be stored in a variety of formats including, for example, text, images, audio, and video. This data may be transcoded before being used to generate feature vectors. For example, where the data is stored as images or video, the contract import engine may generate text from the image or video using an OCR component and use this generated text to generate a feature vector, or element of a feature vector descriptive of the data. Where the data is stored as audio or video, the contract import engine may transcribe the audio or video using an automatic speech recognition (ASR) component (e.g., as may be part of the transcription services 600) and use this transcribed text to generate a feature vector descriptive of the data. In some embodiments, where a field may be described by two or more data sources (e.g., text generated from an image and an audio recitation of the text), the contract import engine may fuse the data from the two or more source to generate a feature vector descriptive of the data. Further, the feature vectors generated in the act 406 may include elements having a variety of formats and values. For example, the values of the feature vector elements may be binary, ordinal, categorical, integer-valued, real-valued, and/or multi-dimensional. Thus the embodiments disclosed herein are not limited to a particular a feature vector element or feature vector set having particular formats or values.

In act 408, the contract import engine uses data descriptive of the identified fields and the generated feature vectors to populate classification data used by one or more contract models. In some embodiments, this classification data is generated by the acts 404 and 406 described above. In other embodiments, this data is supplemented or replaced by data originated by the user as described further below with reference to optional act 1140 of FIG. 3.

The processes executed within the act 408 may vary between embodiments. In one embodiment, in the act 408 the contract import engine trains an artificial neural network using the fields and their associated feature vectors as a set of training data. In another embodiment, in the act 408 the contract import engine assembles the fields and their associated feature vectors to form an exemplar contract. The feature vectors associated with the fields of the exemplar contract can be compared to feature vectors descriptive of data associated with new fields in the new contract to classify the new fields as being of a particular field type. Also in act 408, as needed, the contract import engine stores the classification data in a contract model 50 of a contract model repository (e.g., the contract model repository 306).

Returning to FIG. 3, in the act 1140, which is optional as indicated by use of dashed lines, the interactivity component receives input from a user that expressly specifies the fields that may be included in contracts to be imported and feature vectors of data associated those fields. In response to receiving this input, the interactivity component transmits data descriptive of the input to the contract import engine. In response to receiving the transmitted data, the contract import engine stores the data for subsequent use in generating and populating classification data in the act 408.

In act 1120 the contract import engine classifies a new contract in response to receiving information descriptive of the new contract from a device associated with the user. In some embodiments, the contract import engine may generate a baseline copy of the new electronic contract using this information. The baseline copy of the new electronic contract may be stored as data better suited for the processes described herein. For example, if the information is received in a graphical format, the contract import engine may render the information as text data as store the text data in the baseline copy of the new electronic contract.

In some embodiments, in the act 1120 the contract import engine next performs cluster analysis on the new electronic contract to identify new fields in the new contract. This cluster analysis may be informed by characteristics within the classification data (e.g., size of fields, location of fields, etc.) and the contract import engine may adjust attributes of the field to better fit features of fields described in the classification data. Next, the contract import engine creates a feature vector descriptive of the new contract and searches the metadata for a contract feature vector that is similar to the newly created feature vector (e.g., by using a distance function and thresholds as described above). Responsive to identifying a sufficiently similar contract feature vector (e.g. calculating a distance between a contract feature vector and the newly created feature vector that is less than a configurable threshold), the contract import engine executes a contract model associated with the contract feature vector. This contract model may be the contract model 50 stored in the contract model repository. As discussed above, this contract model may be specific to on one or more parties and/or one or more contract types. Examples of contract models that may be executed by the contract import engine range from simple text and/or frequency-based pattern matching models to sophisticated neural networks.

In another embodiment where the contract model includes an exemplar contract, the contract import engine executes a contract model that compares feature vectors of new fields in the new contract to feature vectors of fields in the exemplar contract in an attempt to find matching, or similar, feature vectors (e.g., feature vectors separated by a distance that is less than a configurable threshold). These feature vectors may include, for example, elements descriptive of content and location of content. The contract model may execute this comparison by calculating a distance a feature vector of a new field and one or more feature vectors of one or more fields of the exemplar contract. Where the distance between the feature vector of the new field and a feature vector of a field of the exemplar contract is below a threshold value (and, in some examples, lower than other calculated distances involving the feature vector associated with the new field instance), the contract import engine stores a field identifier for the new field that indicates the new field has the same field type as the field in the exemplar contract.

In another embodiment, the contract import engine compares data associated with the new field instance and data associated with a field of the exemplar contract. Where the contract import engine determines that the data associated with the new field instance matches more than a threshold percentage of data associated with the field of exemplar contract, the contract import engine stores a field identifier of the new field that indicates the new field has the same field type as the field in the exemplar contract.

In another embodiment where the contract model includes a neural network, the contract import engine provides new fields of the new contract to the neural network as input data. In this embodiment, the neural network classifies each new field as a field type and transmits information descriptive of the field type to the contract import engine. Upon receipt of the data, the contract import engine store a field identifier of the new field that indicates the new field has the field type described in the data received from the neural network.

It is appreciated that, in various embodiments, one or more of the parties to the new electronic contract may be discovered during the execution of the act 1120. One or more of these parties (e.g., the other contract party 200) may not be a current user of the electronic contract system. Where a party to the new electronic contract is not a user of the electronic contract system. The contract import engine may configure a new user account for the other party and issue a notification to the party, if possible (e.g., where an email address of the party is recorded or discovered processes described herein. In this way, some embodiments facilitate the addition of new users and the creation of new user accounts.

In act 1130, which is optional as indicated by use of dashed lines, the contract import engine requests that the interactivity component prompt the user for input confirming or correcting the classification of the new contract fields performed in the act 1120. In response to receiving this input, the contract import engine records any corrections indicated in the input to the classification of the new contract and new contract fields.

In act 1150, which is optional as indicated by use of dashed lines, the contract import engine determines whether the new electronic contract is a copy of an extant electronic contract stored in a contract repository (e.g., the contract repository 302). Whether or not the new electronic contract is a copy of an extant electronic contract may be determined, for example, by comparing the entirety of the contracts, or by comparing identifying fields of the contracts (e.g., parties, execution date, serial number of contracts, etc.). If the new electronic contract is a copy of an extant electronic contract, the contract import engine executes act 1160. Otherwise, the contract import engine executes the act 1170.

In the act 1160, which is optional as indicated by use of dashed lines, the contract import engine requests that the interactivity component prompt a user for input to indicate whether the user would prefer to abort the importation of the new contract. In response to receiving input indicating a preference to abort the importation, the contract import engine deletes all new contract data and terminates the importation process 1000. In response to receiving input that indicates a preference to not abort the importation, the contract import engine executes act 1170.

In the act 1170, the contract import engine transmits notifications to all parties to the new contract. The notifications include information indicating the identity and content of the new contract and the identity of the user importing the contract. Additionally, in the act 1170, the contract import engine stores audit information that records the importation and notification activities described in acts 1110, 1120, and 1170 described above.

In act 1180, which is optional as indicated by use of dashed lines, the contract import engine requests that the interactivity component prompt each party for input to indicate whether the party consents to importation of the new contract. In response to receiving input that indicates no consent to the importation, the contract import engine deletes all new contract data and terminates the importation process 1000. In response to receiving input that indicates consent to the importation, the contract import engine executes act 1200. In act 1200, the contract import engine stores the new contract as an electronic contract in the contract repository and the electronic contract is available for use within the electronic contract system.

In some embodiments, prior to requesting that the interactivity component prompt each party for input in the act 1180, the contract import engine first searches for policy information associated with each party to determine whether a policy regarding importation exists for any parties. The policy information may specify, for example, that importation is consented to or is not consented to. If policy information associated with a party exists, the contract import engine will implement the policy specified in the policy information for that party automatically and without transmitting a request to the interactivity component, unless such action is specified by the policy. This policy information may be stored in association with the user's account in formation in the user account repository 304.

Each of processes described herein depict one particular sequence of acts in a particular example. The acts included in these processes may be performed by, or using, one or more programmable devices specially configured as discussed herein. Some acts are optional and, as such, may be omitted in accord with one or more examples. Additionally, the order of acts can be altered, or other acts can be added, without departing from the scope of the embodiments discussed herein. Furthermore, as discussed above, in at least one example, the acts are performed on a particular, specially configured machine, namely an electronic contract system and associated components that are configured according to the examples and embodiments disclosed herein.

### Further Example Embodiments

According to one embodiment, an electronic contract system is provided. The electroni contract system includes a memory and at least one processor coupled to the memory. The at least one processor is configured to receive information descriptive of an existing contract to be imported into the electronic contract system; analyze the information using a pre-established contract model to identify and extract metadata descriptive of the existing contract; identify at least one party to the existing contract by analyzing the metadata; and store, in the memory, the metadata and an electronic version of the existing contract in association with an identifier of the at least one party, the identifier being associated with a user account for accessing the electronic contract system.

In the electronic contract system, the information descriptive of the existing contract may include at least one of textual data, graphical data, and audio data recorded by a device distinct from the electronic contract system. The at least one processor may be configured to identify the at least one party at least in part by being configured to identify a target pattern within the existing contract, the target pattern identifying parties to a contract in one or more other electronic contracts accessible to the electronic contract system. The at least one processor may be further configured to generate classification data from the one or more other electronic contracts and the at least one processor is configured to identify the target pattern within the electronic version of the existing contract at least in part by being configured to use the pre-established contract model and the classification data. The at least one processor may be further configured to identify the pre-established contract model based on a calculated similarity between the pre-established contract model and the electronic version of the existing contract. The classification data may include information descriptive of one or more locations in the one or more other electronic contracts where the target pattern is located. The classification data may further include information descriptive of a user of the electronic contract system, derived from the user account.

In the electronic contract system, the at least one processor may be configured to use the contract model at least in part by being configured to identify one or more clusters of data in the electronic version of the existing contract, a cluster of the one or more clusters including the target pattern; identify the cluster as including the target pattern; and store, in response identifying the cluster as including the target pattern, an association between the cluster and a field identifier that includes an identifier of the data. The field identifier may include a location identifier that identifies a location of the data, the electronic contract system further comprises an interactivity component coupled to the at least one processor, and the at least one processor may be further configured to display the field identifier and the location identifier via the interactivity component; receive, via the interactivity component, input indicating a corrected location identifier; and replace the location identifier included in the field identifier with the corrected location identifier. The at least one processor may be configured to identify the cluster as including the target pattern by being configured to provide the cluster of data to a neural network; and classify, by executing the neural network, the cluster of data as being of a field type associated with the target pattern.

In the electronic contract system, the at least one processor may be configured to store, in the memory, the electronic version of the existing contract at least in part by being configured to store an importation status value that indicates importation is in-process and the at least one processor may be further configured to retrieve a policy regarding importation of electronic contracts and associated with the at least one party; determine that the policy indicates that the at least one party consents to importation of electronic contracts; and replace, in response to determining that the policy indicates that the at least one party consents, the importation status value with a value that indicates importation is complete.

In the electronic contract system, the at least one processor may be further configured to transmit a notification to the at least one party, the notification being descriptive of the electronic version of the existing contract and notifying the at least one party that the electronic version of the existing contract is being imported into the electronic contract system. The notification may include a prompt for input specifying whether the at least one party consents to importation of the electronic version of the existing contract. The at least one processor may be further configured to, in response to determining that the input indicates no consent, delete the information descriptive of the electronic version of the existing contract, the metadata, and the electronic version of the existing contract. The at least one processor may be further configured to, in response to identifying a party who does not yet have a user account in the electronic contract system, automatically create a user account for the party.

According to another embodiment, a method implemented by an electronic contract system is provided. The method includes acts of receiving information descriptive of an existing contract to be imported into the electronic contact system; analyzing the information using a pre-established contract model to identify and extract metadata descriptive of the existing contract; identifying at least one party to the existing contract by analyzing the metadata; and storing, in a memory, the metadata and an electronic version of the existing contract in association with an identifier of the at least one party, the identifier being associated with a user account for accessing the electronic contract system.

In the method, the act of identifying the at least one party may include an act of identifying a target pattern within the electronic version of the existing contract, the target pattern identifying parties to a contract in one or more other electronic contracts accessible to the electronic contract system. The method may further include an act of generating classification data from the one or more other electronic contracts, wherein identifying the target pattern within the electronic version of the existing contract includes using the pre-established contract model and the classification data.

According to another embodiment, a non-transitory computer readable medium storing computer executable instructions is provided. The computer executable instructions are configured to instruct at least one processor to execute a method of importing contracts. The method includes acts of receiving information descriptive of an existing contract to be imported into the electronic contract system; analyzing the information using a pre-established contract model to identify and extract metadata descriptive of the existing contract; identifying at least one party to the existing contract by analyzing the metadata; and storing, in a memory, the metadata and an electronic version of the existing contract in association with an identifier of the at least one party, the identifier being associated with a user account for accessing the electronic contract system.

The method instructed by the computer executable instructions may include identifying the at least one party by identifying a target pattern within the electronic version of the existing contract, the target pattern identifying parties to a contract in one or more other electronic contracts accessible to the electronic contract system.

Having thus described several aspects of at least one embodiment, it is to be appreciated that various alterations, modifications, and improvements will readily occur to those skilled in the art. For instance, embodiments disclosed herein may also be used in other contexts wherein the recordings include both audio and video data. Such alterations, modifications, and improvements are intended to be part of this disclosure, and are intended to be within the scope of the embodiments discussed herein. Accordingly, the foregoing description and drawings are by way of example only.

What is claimed is:

1. An electronic contract system comprising:
a memory; and
at least one processor coupled to the memory and configured to:
receive information descriptive of an existing contract to be imported into the electronic contract system;
analyze the information using a pre-established contract model to identify and extract metadata descriptive of the existing contract;
identify at least one party to the existing contract by analyzing the metadata; and
store, in the memory, the metadata and an electronic version of the existing contract in association with an identifier of the at least one party, the identifier being associated with a user account for accessing the electronic contract system.

2. The electronic contract system of claim 1, wherein the information descriptive of the existing contract includes at least one of textual data, graphical data, and audio data recorded by a device distinct from the electronic contract system.

3. The electronic contract system of claim 1, wherein the at least one processor is configured to identify the at least one party at least in part by being configured to identify a target pattern within the existing contract, the target pattern identifying parties to a contract in one or more other electronic contracts accessible to the electronic contract system.

4. The electronic contract system of claim 3, wherein the at least one processor is further configured to generate classification data from the one or more other electronic contracts and the at least one processor is configured to identify the target pattern within the electronic version of the existing contract at least in part by being configured to use the pre-established contract model and the classification data.

5. The electronic contract system of claim 4, wherein the at least one processor is further configured to identify the pre-established contract model based on a calculated similarity between the pre-established contract model and the electronic version of the existing contract.

6. The electronic contract system of claim 4, wherein the classification data further includes information descriptive of one or more locations in the one or more other electronic contracts where the target pattern is located.

7. The electronic contract system of claim 4, wherein the classification data further includes information descriptive of a user of the electronic contract system, derived from the user account.

8. The electronic contract system of claim 4, wherein the at least one processor is configured to use the pre-established contract model at least in part by being configured to:
identify one or more clusters of data in the electronic version of the existing contract, a cluster of the one or more clusters including the target pattern;
identify the cluster as including the target pattern; and
store, in response identifying the cluster as including the target pattern, an association between the cluster and a field identifier that includes an identifier of the data.

9. The electronic contract system of claim 8, wherein the field identifier includes a location identifier that identifies a location of the data, the electronic contract system further comprises an interactivity component coupled to the at least one processor, and the at least one processor is further configured to:
display the field identifier and the location identifier via the interactivity component;
receive, via the interactivity component, input indicating a corrected location identifier; and
replace the location identifier included in the field identifier with the corrected location identifier.

10. The electronic contract system of claim 8, wherein the at least one processor is configured to identify the cluster as including the target pattern by being configured to:
provide the cluster of data to a neural network; and
classify, by executing the neural network, the cluster of data as being of a field type associated with the target pattern.

11. The electronic contract system of claim 1, wherein the at least one processor is configured to store, in the memory, the electronic version of the existing contract at least in part by being configured to store an importation status value that indicates importation is in-process and the at least one processor is further configured to:
retrieve a policy regarding importation of electronic contracts and associated with the at least one party;
determine that the policy indicates that the at least one party consents to importation of electronic contracts; and
replace, in response to determining that the policy indicates that the at least one party consents, the importation status value with a value that indicates importation is complete.

12. The electronic contract system of claim 1, wherein the at least one processor is further configured to transmit a notification to the at least one party, the notification being descriptive of the electronic version of the existing contract and notifying the at least one party that the electronic version of the existing contract is being imported into the electronic contract system.

13. The electronic contract system of claim 12, wherein the notification includes a prompt for input specifying whether the at least one party consents to importation of the electronic version of the existing contract.

14. The electronic contract system of claim 13, wherein the at least one processor is further configured to, in response to determining that the input indicates no consent, delete the information descriptive of the electronic version of the existing contract, the metadata, and the electronic version of the existing contract.

15. The electronic contract system of claim 1, wherein the at least one processor is further configured to, in response to identifying a party who does not yet have a user account in the electronic contract system, automatically create a user account for the party.

16. A method implemented by an electronic contract system, the method comprising:
receiving information descriptive of an existing contract to be imported into the electronic contact system;
analyzing the information using a pre-established contract model to identify and extract metadata descriptive of the existing contract;
identifying at least one party to the existing contract by analyzing the metadata; and
storing, in a memory, the metadata and an electronic version of the existing contract in association with an identifier of the at least one party, the identifier being associated with a user account for accessing the electronic contract system.

17. The method of claim 16, wherein identifying the at least one party includes identifying a target pattern within the electronic version of the existing contract, the target pattern identifying parties to a contract in one or more other electronic contracts accessible to the electronic contract system.

18. The method of claim 17, further comprising generating classification data from the one or more other electronic contracts, wherein identifying the target pattern within the electronic version of the existing contract includes using the pre-established contract model and the classification data.

19. A non-transitory computer readable medium storing computer executable instructions configured to instruct at least one processor to execute a method of importing contracts, the method comprising:
receiving information descriptive of an existing contract to be imported into the electronic contract system;
analyzing the information using a pre-established contract model to identify and extract metadata descriptive of the existing contract;
identifying at least one party to the existing contract by analyzing the metadata; and
storing, in a memory, the metadata and an electronic version of the existing contract in association with an identifier of the at least one party, the identifier being associated with a user account for accessing the electronic contract system.

20. The computer readable medium of claim 19, wherein identifying the at least one party includes identifying a target pattern within the electronic version of the existing contract, the target pattern identifying parties to a contract in one or more other electronic contracts accessible to the electronic contract system.
